(19) United States
(12) Patent Application Publication
(10) Pub. No.: US 2003/0182561 A1
(43) Pub. Date: Sep. 25, 2003

(54) Tamper detection mechanism for a personal computer and a method of use thereof

(75) Inventors: David Carroll Challener, Raleigh, NC (US); Steven Dale Goodman, Raleigh, NC (US); James Patrick Hoff, Raleigh, NC (US); Hernando Ovies, Cary, NC (US); Randall Scott Springfield, Chapel Hill, NC (US); James Peter Ward, Raleigh, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/105,917

(22) Filed: Mar. 25, 2002

(51) Int. Cl. H04L 9/32

(52) U.S. Cl. 713/189

(57) ABSTRACT

A tamper detection mechanism for a personal computer (PC) and a method of use thereof is disclosed. Accordingly, a first aspect of the present invention comprises a tamper detection mechanism. The tamper detection mechanism comprises a first Root-of Trust Measurement (RTM) module which is coupled to and fixed within the PC, a second RTM module being removably attached to the PC and a diagnostic program for comparing a copy of the first RTM module with a copy of the second RTM module to determine whether the first RTM module is valid. A second aspect of the present invention comprises a method of provided tamper detection for a PC. The method comprises providing a first RTM module, providing a second RTM module and utilizing a diagnostic program to compare a copy of the first RTM module with the a copy of the second module to determine whether the first RTM module is valid. Through the use of the present invention, an extra level of tamper protection is added to the PC since it would require an attacker to disable the RTM module as well as the diagnostic program. Additionally, the preferred embodiment of the present invention provides cost differentiation to the Original Equipment Manufacturer whereby customers that do not want or need this level of protection can be provided with platforms that are built without it at a substantially lower cost.

### FIELD OF INVENTION

The present invention relates generally to the field of computer security and particularly to a tamper detection mechanism for a personal computer (PC) and a method of use thereof.

### BACKGROUND OF THE INVENTION

Personal computer systems in general have attained widespread use for providing computer power to many segments of today's modem society. Personal computer systems can usually be defined as a desktop, floor standing, or portable microcomputer that comprises a system unit having a single system processor and associated volatile and non-volatile memory. FIG. 1 is an example of a conventional personal computer system 10. The personal computer system 10 typically includes an associated display monitor 11, a keyboard 12, one or more diskette drives 13 and an associated printer 14.

With the phenomenal growth and use of personal computers in the world in recent years, more and more data or information is being collected and retained or stored in such systems. Oftentimes data is sensitive in nature. As more users recognize the sensitive nature of data and its value, the more it becomes desirable to protect against misuse. In light of this, the level, or “amount”, of security upon which a great deal of the information depended, needed to be increased. At the same time, security parameters for PCs need to be easy to deploy, use and manage.

In computer platforms adhering to hardware based security protection schemes, trusted information such as private keys, digital certificates, random number generators, protected storage and the immutable portion of BIOS initialization code that executes when the PC is reset otherwise known as the Root-of-Trust Measurement, reside on two hardware chips within the platform, the Trusted Platform Module (TPM) and the Root-of-Trust Measurement (RTM) Module. Typically, the robustness of the security provided by PCs using a TPM and RTM subsystem is usually verified by independent test labs.

One of the items that should be verified during such evaluations is tampering of the hardware modules and to what extent this type of intrusion is evident to the PC owner. Tampering of the RTM by hackers could leave the PC owner vulnerable to the platform initialization being modified without their knowledge to gain access to private keys and digital certificates or to change the trusted parameters of the platform. Traditionally, physical tape labels have been placed over an RTM module to provide evidence of a tampering. A problem with this technique is that it can be easily defeated by carefully replacing the physical label after the tampering has taken place.

Another problem with this approach in the PC marketplace is the cost involved in adding these physical tape labels to all PCs using RTM chips during the manufacturing process when only a specific set of customers (like government agencies, banks and the military in large special bid situations) need this level of protection.

Accordingly, what is needed is a tamper detection solution for the above-outlined problems. The solution should be simple, cost effective and capable of being easily adapted to current technology. The present invention addresses such a need.

### SUMMARY OF THE INVENTION

A tamper detection mechanism for a personal computer (PC) and a method of use thereof is disclosed. Accordingly, a first aspect of the present invention comprises a tamper detection mechanism. The tamper detection mechanism comprises a first Root-of Trust Measurement (RTM) module which is coupled to and fixed within the PC, a second RTM module being removably attached to the PC and a diagnostic program for comparing a copy of the first RTM module with a copy of the second RTM module to determine whether the first RTM module is valid.

A second aspect of the present invention comprises a method of providing tamper detection for a PC. The method comprises providing a first RTM module, providing a second RTM module and utilizing a diagnostic program to compare a copy of the first RTM module with a copy of the second RTM module to determine whether the first RTM module is valid.

Through the use of the present invention, an extra level of tamper protection is added to the PC since it would require an attacker to disable the RTM module as well as the diagnostic program. Additionally, the preferred embodiment of the invention provides cost differentiation to the Original Equipment Manufacturer (OEM) whereby customers that do not want or need this level of protection can be provided with platforms that are built without it at a substantially lower cost.

### BRIEF DESCRIPTION OF THE DRAWINGS

FIG. 1 is an example of a typical personal computer system.

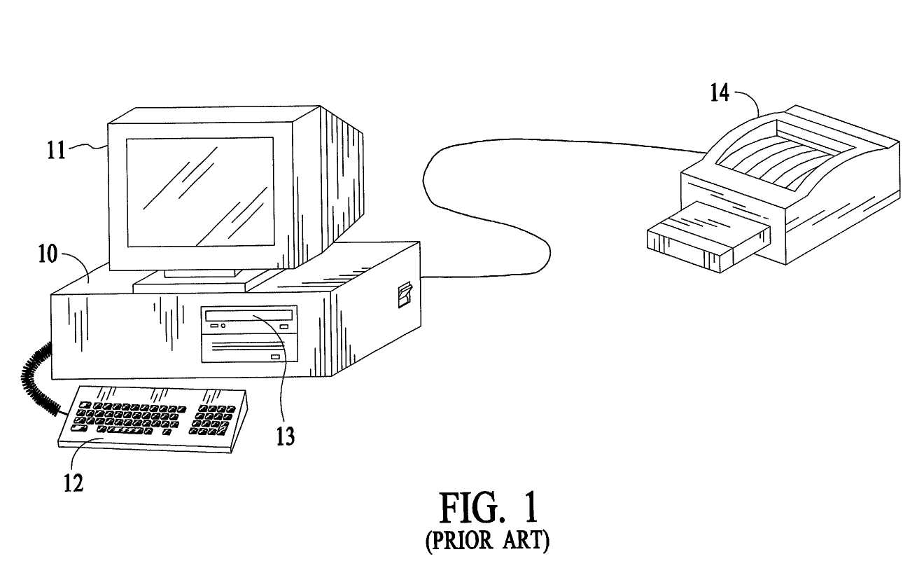

FIG. 2 shows a system in accordance with the present invention.

FIG. 3 is a flowchart of the method in accordance with the present invention.

### DETAILED DESCRIPTION OF THE INVENTION

The present invention provides a tamper detection mechanism for a personal computer and a method of use thereof. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiments shown but is to be accorded the widest scope consistent with the principles and features described herein.

The present invention is presented in the context of a preferred embodiment. The preferred embodiment of the present invention is a tamper detection mechanism for a PC and a method of use thereof. Through the use of the present invention, an extra level of tamper protection is added to the PC since it would require an attacker to disable the RTM module as well as the diagnostic program. Additionally, the preferred embodiment of the present invention provides cost differentiation to the Original Equipment Manufacturer (OEM) whereby customers that do not want or need this level of protection can be provided with platforms that are built without it at a substantially lower cost.

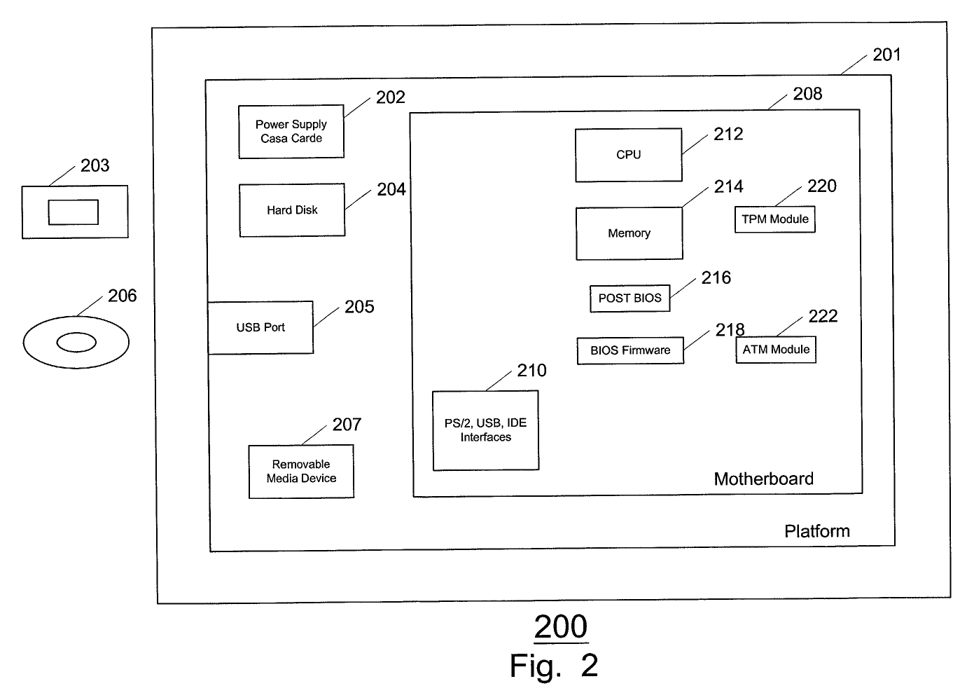

As previously stated, in many computer platforms, trusted information such as private keys, digital certificates, random number generators, protected storage and the Root-of-Trust Measurement, reside on two hardware chips within the platform, the Trusted Platform Module (TPM) and the Root-of-Trust Measurement (RTM) Module. For a better understanding, please refer now to FIG. 2. FIG. 2 shows a preferred embodiment of a system 200 in accordance with the present invention that incorporates such a platform. The system 200 comprises a platform 201, wherein the platform 201 comprises power supply case cards 202, a hard disk 204, a Universal Serial Bus (USB) port 205, a removable media device 207, and a motherboard 208. The motherboard 208 comprises USB and Integrated Drive Electronics (IDE) Interfaces 210, a central processing unit 212, a computer memory 214, the POST/BIOS executable code 216, the BIOS firmware 218, the TPM Module 220 and the RTM Module 222. The system 200 also includes a USB FOB carrier 203 and a diagnostic program 206.

In order to provide tamper evidence for the RTM module 222 and protect the platform user, two permanent memory modules are created that include identical copies of the RTM code. One permanent memory module is provided within the PC (RTM Module 222) and the other permanent memory module is provided on the USB compatible FOB carrier 203. The USB FOB carrier 203 with the RTM copy is shipped with the PC along with the diagnostic program 206 residing on removable media (diskette or CD).

The diagnostic program 206 is used to compare the contents of the platform RTM module 222 to those of the USB FOB carrier copy 203. In a preferred embodiment, the diagnostic program 206 is invoked by the PC owner during the platform 201 power-up cycle by inserting the USB FOB carrier 203 containing the RTM copy into the USB port 205 and inserting the removable media containing the diagnostic program 206 into the removable media device 207. The program 206 will then verify that the RTM code on the RTM module 222 is identical to the one shipped from the OEM on the USB FOB carrier 203. If this is true, then the PC user knows that the RTM module 222 is valid and has not been tampered with or modified by any physical or network tampering attacks.

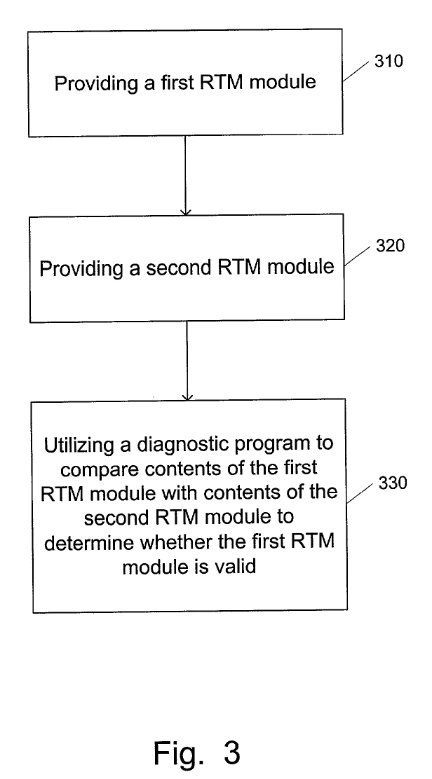

To further understand the method in accordance with the present invention, please refer now to FIG. 3. FIG. 3 is a flowchart of the method in accordance with the present invention. Initially, a first RTM module is provided, via step 310. Preferably, this module is coupled to and fixed to within the personal computer. Next, a second RTM module is provided, via step 320. Preferably, this module resides on a USB FOB carrier and is capable of being removably attached to the PC. Finally, a diagnostic program is utilized to compare a copy of the first RTM module with a copy of the second RTM module to determine whether the first RTM module is valid, via step 330. Preferably, the diagnostic program resides on removable media and is invoked by the PC to compare the first RTM module to the second RTM module in order to determine if they are identical. If they are not identical, then the user knows that a tamper attack has taken place.

Although the preferred embodiment of the present invention is described in the context of being utilized in conjunction with any personal computer, one of ordinary skill in the art will readily recognize that the associated functionality could be implemented based on specified computer security guidelines while remaining within the spirit and scope of the present invention. For example, the Trusted Computing Platform Alliance (TCPA) is an open alliance formed by a large group of companies. This alliance administrates specific computer security parameters based on articulated guidelines. Accordingly, the method and system in accordance with the present invention could be implemented in accordance with TCPA guidelines.

The preferred embodiment of the present invention is beneficial to the OEM in that it provides the OEM with cost differentiation based on the specific set of customers that would need this level of tamper protection. These customers would include government agencies, banks, military, etc. Accordingly, customers that do not want or need this level of protection can be provided with platforms that are built without it at a substantially lower cost.

Additionally, computer security guidelines, for example the TCPA guidelines, may provide for the optional capability for the maintenance of the TPM and RTM code via firmware upgrades. The use of the present invention can provide the OEM with an integrity check of the RTM code in the platform that is about to be upgraded in order to determine whether it has been tampered with and/or modified before initializing the upgrade. Also, if the RTM code is in fact changed during an OEM initiated upgrade, the PC owner is provided with a new FOB carrier containing the new RTM code.

Through the use of the present invention, an extra level of tamper protection is added to the PC since it would require an attacker to disable to disable the RTM module as well as the diagnostic program.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A tamper detection mechanism for a personal computer (PC) comprising:
a first Root-of Trust Measurement (RTM) module which is coupled to and fixed within the PC;
a second RTM module being removably attached to the PC; and
a diagnostic program for comparing a copy of the first RTM module with a copy of the second RTM module to determine whether the first RTM module is valid.

2. The mechanism of claim 1 wherein the copy of the first RTM module is identical to the copy of the second RTM module.

3. The mechanism of claim 1 wherein the second RTM module is within a Universal Serial Bus FOB carrier.

4. The mechanism of claim 1 wherein the diagnostic program is within a removable media.

5. The mechanism of claim 1 wherein the PC includes a USB port and a removable media device and the diagnostic program is invoked by inserting the USB FOB carrier into the USB port and inserting the removable media into the removable media device during a power up cycle.

6. The mechanism of claim 1 wherein the personal computer is a Trusted Computing Platform Alliance (TCPA) compliant personal computer.

7. A method of provided tamper detection for a personal computer (PC), the method comprising the steps of:
a) providing a first RTM module;
b) providing a second RTM module; and
c) utilizing a diagnostic program to compare contents of the first RTM module with contents of the second RTM module in order to determine whether the first RTM module is valid.

8. The method of claim 7 wherein step c) further comprises:
c1) allowing the PC to invoke the diagnostic program; and
c2) utilizing the diagnostic program to compare contents of the first RTM module with contents of the second RTM module in order to determine if they are identical.

9. The method of claim 8 wherein the second RTM module resides on a USB FOB carrier and the diagnostic program resides on a removable media.

10. The method of claim 9 wherein the PC includes a USB port and a removable media device and step c1) further comprises:
c1a) inserting the USB FOB carrier into the USB port; and
c1b) inserting the removable media into the removable media device during a power up cycle.

11. The method of claim 10 wherein the personal computer is a Trusted Computing Platform Alliance (TCPA) compliant personal computer.

12. A computer system comprising:
a central processing unit (CPU);
a memory coupled to the CPU; and
a tamper detection mechanism, the tamper detection mechanism being responsive to the CPU, the tamper detection mechanism comprising a first Root-of Trust Measurement (RTM) module which is coupled to and fixed within the system, a second RTM module being removably attached to the system, and a diagnostic program for comparing a copy of the first RTM module to a copy of the second RTM module to determine whether the first RTM module is valid.

13. The system of claim 12 wherein the copy of the first RTM module is identical to the copy of the second RTM module.

14. The system of claim 12 wherein the second RTM module is within a Universal Serial Bus FOB carrier.

15. The system of claim 12 wherein the diagnostic program is within a removable media.

16. The system of claim 12 further comprising a USB port and a removable media device wherein the diagnostic program is invoked by inserting the USB FOB carrier into the USB port and inserting the removable media into the removable media device during a power up cycle.
